(19) United States
(12) Patent Application Publication
(10) Pub. No.: US 2026/0251553 A1
(43) Pub. Date: Aug. 27, 2026

(54) Multi-Function Optical Analyzer

(71) Applicant: Board of Trustees of Michigan State University, East Lansing, MI (US)

(72) Inventor: Qi Hua FAN, Okemos, MI (US)

(73) Assignee: Board of Trustees of Michigan State University, East Lansing, MI (US)

(21) Appl. No.: 19/548,067

(22) Filed: Feb. 24, 2026

Related U.S. Application Data
(60) Provisional application No. 63/762,888, filed on Feb. 25, 2025.

(51) Int. Cl. G01N 21/21; G01B 11/06

(52) U.S. Cl. CPC G01N 21/211; G01B 11/0625; G01B 11/0641; G01N 2021/213; G01N 2021/215; G01N 2201/086

(57) ABSTRACT

A multi-function optical analyzer and method are configured to measure optical properties of materials. In another aspect of the present apparatus and method, a single instrument synergistically measures a refractive index, an extinction coefficient, a thickness, an optical reflectance, and an optical transmittance of a thin film. An aspect of the present optical analyzer apparatus and method transmit light along multiple offset-angled paths to a sample, and reflect the light along multiple offset-angled paths from the specimen to a spectrometer detector. Still another aspect of the present apparatus and method primarily measure a reflectance spectra of an s-wave at oblique angles and non-polarized light at a normal incident angle. This combines the functions of two instruments—an ellipsometer and a spectrophotometer.

### CROSS-REFERENCE TO RELATED APPLICATION

The present application claims priority to U.S. provisional application Ser. No. 63/762,888, filed on Feb. 25, 2025, which is incorporated by reference herein.

### BACKGROUND AND SUMMARY

The present application generally pertains to a multi-function optical analyzer and more particularly to an instrument and method that can measure optical properties of materials.

Thin films are the fundamental materials in many optoelectronic devices and components. A few examples include low-E glass coatings, flat panel displays, solar cells, and optical filters. In these applications, one or more layers of thin films with different optical properties and thicknesses are used to realize a specific optical performance, such as anti-reflection coatings. A basic physical property that determines the coatings' optical performance is the complex refractive index N=n−jk of each layer and the substrate, where n is the refractive index, k is the extinction coefficient, and j is the imaginary number. The n and k values vary with wavelength due to light-material interactions. Determining the complex refractive indices of thin films and substrate materials is desirable for optical designs.

Ellipsometry is a traditional method to measure thin film optical properties. An ellipsometer measures the p-wave and s-wave ratio of a polarized light reflected from a sample surface. The thin film refractive index n, extinction coefficient k, thickness, surface roughness, interfacial regions, crystallinity, and many more material properties could be extracted through a model-based fitting. On the other hand, this method disadvantageously requires comprehensive knowledge and complementary information about the analyzed thin films, in advance of the measurement, in order to build an accurate model and subsequently imposes several challenges: (1) highly skilled and experienced users are required—the operators must be experienced with in-depth knowledge of materials science and optical physics, based on which correct models could be established; (2) difficultly in analyzing unknown materials—a completely unknown material with complex interaction mechanisms with light requires many trials to develop a model; (3) it lacks complementary optical measurement capability—an ellipsometer measures reflectance at an angle close to the Brewster condition to maximize the sensitivity, such that a separate and additional spectrophotometer is needed to measure the transmittance and reflectance of optical coatings at a normal incident angle; and (4) high costs—ellipsometers are expensive due to the highly precise electromechanical components, some of which have to rotate with accurate control during the measurement.

Examples of conventional ellipsometers are disclosed in U.S. Pat. No. 8,319,966 entitled “Optical Metrology Systems and Methods” which issued to Zawaideh, et al., on Nov. 27, 2012, and U.S. Pat. No. 7,336,361 entitled “Spectroscopic Ellipsometer and Polarimeter Systems” which issued to Liphardt, et al., on Feb. 26, 2008. These patents are incorporated by reference herein. These patents primarily rely upon p-wave reflectance measurements while also requiring complex calibration procedures and/or complex mathematical simulation/modelling based on pre-measurement knowledge of the film. More specifically, the traditional systems of these patents use data fitting to derive a film refractive index, which requires building an accurate model by highly experienced users.

In accordance with the present invention, a multi-function optical analyzer and method are configured to measure optical properties of materials. In another aspect of the present apparatus and method, a single instrument synergistically measures a refractive index, an extinction coefficient, a thickness, an optical reflectance, and an optical transmittance of a thin film. An aspect of the present optical analyzer apparatus and method transmit light along multiple offset-angled paths to a sample, and reflect the light along multiple offset-angled paths from the specimen to a spectrometer detector to ensure measurement accuracy.

A further aspect includes a light source emitting light from multiple transmitting fiber ends which are offset-angled from each other, at least one of which is offset angled 45-75 degrees from a normal direction relative to a sample, ends of receiving fibers being offset-angled from each other and receiving the light reflected back from the sample, and an s-wave polarizer. Still another aspect of the present apparatus and method primarily measure a reflectance spectra of an s-wave at oblique angles and non-polarized light at a normal incident angle. Thus, this aspect advantageously allows a computation program to automatically and directly compute a film index and thickness, without the need for simulations/modelling-based fitting, which otherwise requires pre-measurement knowledge of the film. Yet another aspect employs larger light receiving fibers than light incident fibers. An additional aspect of the present apparatus and method includes software of a computation program with a user interface, which are configured to automatically: turn on a light source to emit light at a specimen, obtain s-wave optical reflectance spectra at multiple incident angles from a spectrometer, determine a refractive index from the spectra, calculate a refractive index and a film thickness at a wavelength with substantially no optical absorption, and calculate an extinction coefficient at a wavelength of interest.

The present instrument beneficially measures the reflectance spectra of polarized light at two angles to directly calculate the material's complex refractive index N. Furthermore, the present instrument can also measure the transmittance and reflectance spectra of coatings at normal incidence. Therefore, it advantageously combines the basic functions of two instruments—an ellipsometer and a spectrophotometer, into a single synergistic analyzer which can perform both functions in a simultaneous manner, but uses a different principle and method from ellipsometry. Since all the components are static in a preferred construction, the instrument costs are low. Most importantly, this instrument is particularly user-friendly—it does not require comprehensive training and knowledge of the measured materials due to its direct measurement and computation nature.

It is also notable that the present analyzer's use of s-wave instead of p-wave, advantageously avoids the potential problem of multiple solutions, which could be caused by using p-wave. In an optional aspect, the automated software and computation program of the present analyzer allow for real-time and fast measurement and computational results regarding unknown and/or complex film composition samples, without the laborious and time-consuming need for traditional curve fitting. Additional features and benefits will become apparent from the following description and appended claims taken in conjunction with the accompanying drawings.

### BRIEF DESCRIPTION OF THE DRAWINGS

FIG. 1 is a diagrammatic view showing a first embodiment of the present multi-function optical analyzer;

FIG. 2 is a diagrammatic view showing electric field components of light waves;

FIG. 3 depicts graphs showing p-wave and s-wave at an interface between two media;

FIG. 4 is a graph showing typical reflectance at a simple interface dependence on the incident angle for p-wave and s-wave;

FIG. 5 is a diagrammatic view showing expected light reflection and transmission at an air/film interface, and inside a film and a substrate, where N₀, N₁, and N₂ are the complex refractive indices of air, the film and the substrate, but multiple reflections inside the film are not shown for simplicity;

FIG. 6 is a graph showing expected reflectance spectra of a sample consisting of a film and substrate, at different angles, employing the present multi-function optical analyzer;

FIG. 7 is a graph showing an expected derived refractive index n and an extinction coefficient k of an SiO₂ thin film deposited on crystalline Si wafer, employing the present multi-function optical analyzer;

FIG. 8 is a graph showing an expected transmittance spectra of an Nb₂O₅/glass sample measured using a commercial spectrophotometer and the present multi-function optical analyzer;

FIG. 9 is a graph showing an expected reflectance spectra of a SiO₂ coated Si wafer measured at normal incidence using a commercial spectrophotometer and the present multi-function optical analyzer;

FIG. 10 is a diagrammatic view showing a second embodiment of the present multi-function optical analyzer;

FIG. 11 is a software logic flow diagram employed in the present multi-function optical analyzer;

FIGS. 12 and 13 are graphic user interfaces for a computer display screen employed in the present multi-function optical analyzer; and

FIG. 14 is a diagrammatic view showing a third embodiment of the present multi-function optical analyzer.

### DETAILED DESCRIPTION

The present multi-function optical analyzer is configured to determine refractive index, extinction coefficient and film thickness of bulk materials and thin films grown on a substrate by measuring oblique and normal incident reflectance spectra of polarized light or measuring multiple oblique incident reflectance spectra. Furthermore, the present optical analyzer is also configured to measure the transmittance and reflectance spectra of film coating on substrate samples. The present analyzer and method of using same are ideally suited for use in a batch laboratory setting, or for continuous and high quantity manufacturing of optical filters, a large glass coating line for flat panel display screens, coated photovoltaic panels, or the like.

While SiO₂ and Nb₂O₅ thin films on Silicon and glass substrates are disclosed hereinafter as examples, other substrate materials such as metal or the like, and alternate dielectric and semiconductor films may be employed. Non-limiting examples of films include mixtures of metals, oxides and Silicon, such as Silicon+Silicon oxide, Silicon+Silicon Nitride, Silicon+Silver, and Silicon+oxy-nitride, however, other metallic and oxide compositions may be used, such as Indium oxide+Tin oxide, Tantalum oxide+Tin oxide, and the like. The present thickness determination and transmittance/reflectance measurements are advantageous for manufacturing processes since only a single instrument assembly is needed, as compared to the traditional need for multiple independently operating instruments, thereby reducing complexity, saving expense and reducing manufacturing line space. As used herein, the term “film” includes a thin coating layer, such that the terms film and coating may be interchangeably used herein.

A preferred embodiment of the present multi-function optical analyzer and method of using the multi-function optical analyzer, include: (a) determining the refractive index of a film by measuring an optical s-wave reflectance spectrum from a sample surface at an offset incident angle in the range of 45-75 degrees relative to a film plane defined by an exterior surface of the film; (b) measuring an optical reflectance spectrum from the sample surface at an nominal incident angle of 0 degrees (i.e., perpendicular) relative to the film plane; and (c) calculating the variable parameters in the equations (1)-(13) as set forth below, to determine a film thickness d. These measurements, calculations and determinations are preferably conducted in an automated manner using software instructions installed on and stored in non-transient RAM, ROM or removable memory, and run in a microprocessor of a programmable controller. The software instructions automatically determine the film thickness and then automatically display the resultant values on an output display screen. In automatic production, the film thickness is optionally compared to a predetermined design value in order to automatically determine if the thickness is within a desired range for quality control purposes. In large-scale coatings, multiple transmittance, reflectance and thickness measurements and calculations will be automatically taken on each sample to determine if there are any unacceptable coating thickness variances for each panel, and then the controller will automatically send out an output warning and display value deviations if there are.

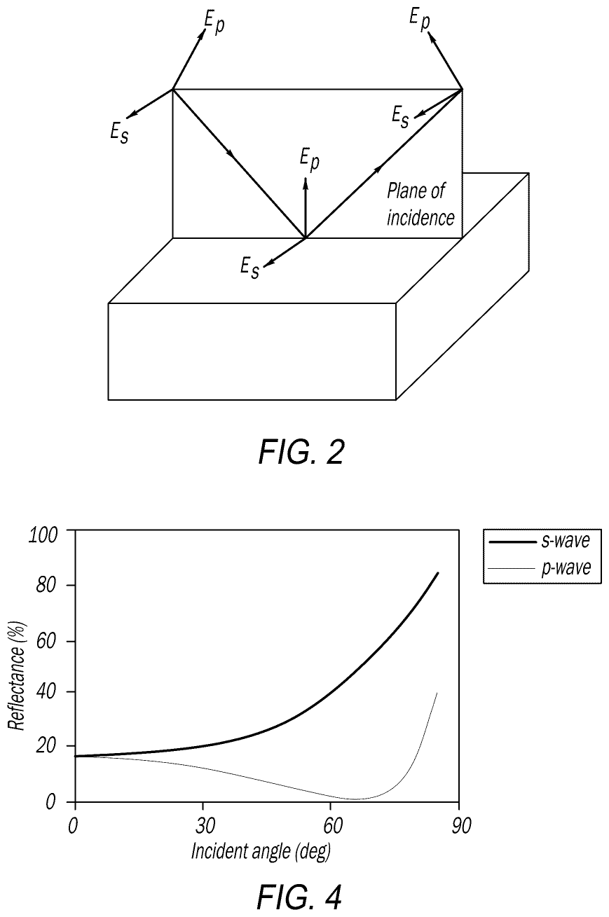

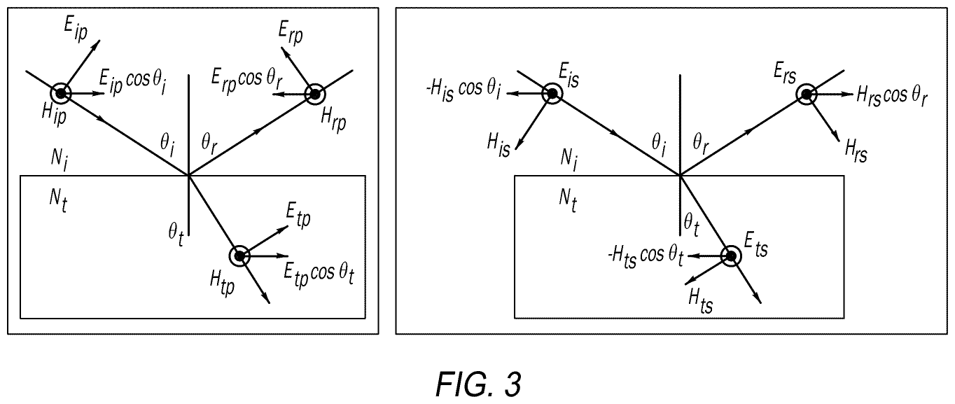

Light is an electromagnetic wave consisting of a p-component Eₚ (p-wave) and s-component Es (s-wave) as illustrated in FIG. 2. When a light beam reaches an interface between two media, part of the light will be reflected and part transmitted. Fundamental electromagnetic boundary conditions require that the electric field E and magnetic field H components parallel to the interface be continuous at the interfaces, as depicted in FIG. 3. E and H are related to each other through the optical admittance Y=H/E. Hence, p-wave and s-wave have different reflection characteristics. The reflection coefficients of p-wave and s-wave, rₚ and rₛ, are expressed in Equations (1) and (2) below.

$${r}_{p} = \frac{{E}_{rp}}{{E}_{ip}} = \frac{{N}_{t} {cosθ}_{i} - {N}_{i} {cosθ}_{t}}{{N}_{t} {cosθ}_{i} + {N}_{i} {cosθ}_{t}} \qquad ( 1 )$$

$${r}_{s} = \frac{{E}_{rs}}{{E}_{is}} = \frac{{N}_{i} {cosθ}_{i} - {N}_{t} {cosθ}_{t}}{{N}_{i} {cosθ}_{i} + {N}_{t} {cosθ}_{t}} \qquad ( 2 )$$

where Nᵢ and Nₜ are the complex refractive indices of the two media, θ is the angle between the light beam and surface normal, subscriptions p and s refer to p-wave and s-wave, and subscriptions i, r, and t refer to incidence, reflection, and transmission. Snell's law and the law of reflection describe the relationships between the angles of incident, reflected, and refracted rays as shown in Equations (3) and (4) below.

$${N}_{i} {sinsθ}_{i} = {N}_{t} {sinsθ}_{t} \qquad ( 3 )$$

$${θ}_{i} = {θ}_{r} \qquad ( 4 )$$

Equations (1)-(4) imply that rₚ and rₛ are generally different at 0°<θᵢ<90°, except at θᵢ=0 they have the same magnitude. The coefficients rₚ and rₛ are usually complex numbers. The measured p-wave and s-wave reflectance Rp and Rs are the products of the corresponding reflection coefficients and their conjugates, i.e.,

$${R}_{p} = {r}_{p} {r}_{p}^{*} \qquad ( 5 )$$

$${R}_{s} = {r}_{s} {r}_{s}^{*} \qquad ( 6 )$$

where * refers to the conjugate. The nature of p-wave and s-wave results in their distinct reflectance characteristics as illustrated in FIG. 4. At a simple interface between two media, the p-wave reflectance has a minimum at the Brewster angle OB, while s-wave reflectance monotonically increases with the incident angle. An ellipsometer measures the ratio of rₚ and rₛ around the Brewster angle θ_{B}, as expressed in Equation (7) below, and fits the measured w and A using the complex refractive indices as variants.

$$ρ = tan ψexp ( j Δ ) = \frac{{r}_{p}}{{r}_{s}} = \frac{( \frac{{E}_{rp}}{{E}_{ip}} )}{( \frac{{E}_{rs}}{{E}_{is}} )} \qquad ( 7 )$$

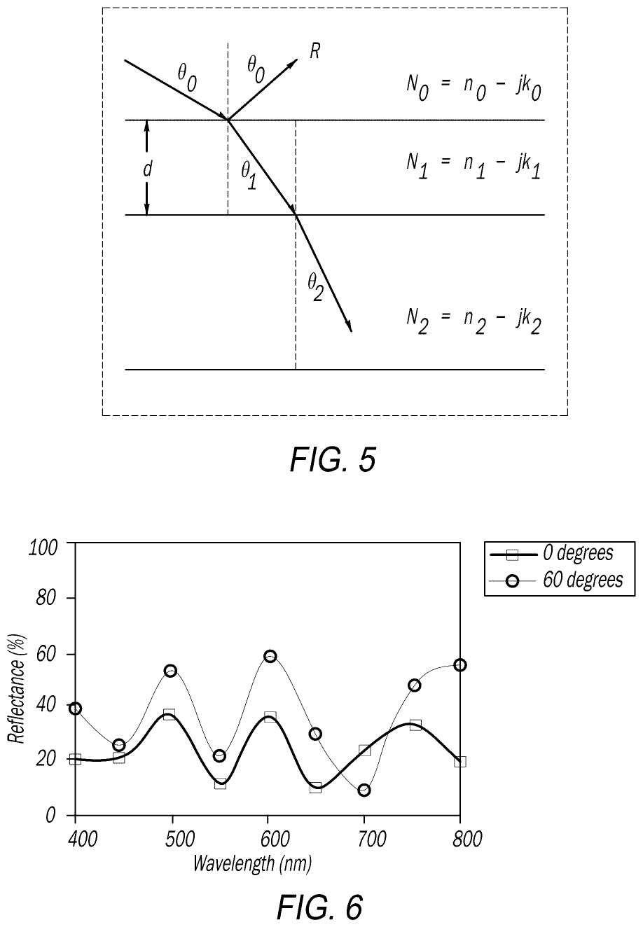

When a thin film is coated on a substrate (e.g., SiO₂ on Si) as shown in FIG. 5, the p-wave Brewster angle shifts to a lower or higher value, depending on the refractive indices of the substrate and the film. The reflectance spectra of s-wave at the air/film interface still have similar characteristics as illustrated in FIG. 4 as long as the film is not too thick. Even if the film is thick, the s-wave reflectance is still a single-value function of wavelength and is very different at 0 degrees and large incident angles. Air can be approximately considered as vacuum with a refractive index of n₀=1 and extinction coefficient of k₀=0. Hence, a general expression of reflectance R for p-wave and s-wave is

$$R = ( \frac{{η}_{0} - Y}{{η}_{0} + Y} ) {( \frac{{η}_{0} - Y}{{η}_{0} + Y} )}^{*} \qquad ( 8 )$$

where η₀ is the admittance of air and Y is the admittance of the film and substrate assembly. p-wave and s-wave have different η₀ and Y under oblique incidence.

Here, the focus is on s-wave because their reflectance varies monotonically with the incident angle at a simple air/material interface, which relaxes the requirement for the incident angles to determine materials' complex refractive indices using this disclosed multi-function optical analyzer, as discussed further in the next paragraphs. Furthermore, s-wave are beneficial to use in the present apparatus and method, as compared to p-wave, given the higher signal-to-noise ratio of s-wave. The expressions for s-wave Y and η₀ are given below.

$$y = \frac{{η}_{2} cosδ + {j η}_{1} si nδ}{cosδ + j ( {η}_{2} / {η}_{1} ) s i n δ} \qquad ( 9 )$$

$${η}_{0} = ( {n}_{0} - j {k}_{0} ) {cosθ}_{0} \qquad ( 10 )$$

$${η}_{1} = ( {n}_{1} - j {k}_{1} ) {cosθ}_{1} \qquad ( 11 )$$

$${η}_{2} = ( {n}_{2} - j {k}_{2} ) {cosθ}_{2} \qquad ( 12 )$$

$$δ = 2 π ( {n}_{1} - j {k}_{1} ) {d cosθ}_{1} / λ \qquad ( 13 )$$

where η₀, n₀, and k₀ are the admittance, refractive index, and extinction coefficient of air; η₁, n₁, and k₁ are the admittance, refractive index, and extinction coefficient of the film; η₂, n₂, and k₂ are the admittance, refractive index, and extinction coefficient of the substrate; δ is the optical phase; λ is the wavelength; and θ₀, θ₁, and θ₂ are the incident angle, refractive angle in the film, and refractive angle in the substrate. With a given incident angle θ₀, Snell's law can be used to determine θ₁ and θ₂.

The above analysis leads to the following notable conclusions that establish the principle of this disclosed multi-function optical analyzer:
With a known substrate complex refractive index n₂−jk₂ and film thickness d, the reflectance R of s-wave at a given incident angle and wavelength λ depends only on the complex refractive index of the film n₁−jk₁, i.e., R(λ)=f[n₁(λ), k₁(λ)].
Since the s-wave reflectance is a monotonic or single-valued function of the wavelength, two measurements of the s-wave reflectance R_{θ01} and R_{θ02} at different incident angles of θ₀₁ and θ₀₂ should result in a set of unique solutions of n₁ and k₁ at a given wavelength of λ, as depicted in the following functions.

$${R}_{θ 01} ( λ , {θ}_{01} ) = f [ {n}_{1} ( λ ) , {k}_{1} ( λ ) , {θ}_{01} ] \qquad ( 14 )$$

$${R}_{θ 02} ( λ , {θ}_{02} ) = f [ {n}_{1} ( λ ) , {k}_{1} ( λ ) , {θ}_{02} ] \qquad ( 15 )$$

Most optical coatings are dielectric materials, which have negligible absorption in the long wavelength range. This implies the film extinction coefficient is k₁=0 in the long wavelength range. Hence, the film thickness can be also determined from two measurements of the s-wave reflectance at different incident angles of θ₀₁ and θ₀₂ at a specific long wavelength of λ_{L}, as depicted in the following functions.

$${R}_{θ 01} ( {λ}_{L ′} ′ {θ}_{01} ) = f [ {n}_{1} ( {λ}_{L} ) , d , {θ}_{01} ] \qquad ( 16 )$$

$${R}_{θ 02} ( {λ}_{L ′} ′ {θ}_{02} ) = f [ {n}_{1} ( {λ}_{L} ) , d , {θ}_{02} ] \qquad ( 17 )$$

A more comprehensive case is to measure the s-wave reflectance R_{θ01}, R_{θ02}, and R_{θ03} at three different incident angles of θ₀₁, θ₀₂, and θ₀₃, which should result in a set of unique solutions of n₁, k₁, and d at a given wavelength of λ, as depicted in the following functions.

$${R}_{θ 01} ( λ , {θ}_{01} ) = f [ {n}_{1} ( λ ) , {k}_{1} ( λ ) , d , {θ}_{01} ] \qquad ( 18 )$$

$${R}_{θ 02} ( λ , {θ}_{02} ) = f [ {n}_{1} ( λ ) , {k}_{1} ( λ ) , d , {θ}_{02} ] \qquad ( 19 )$$

$${R}_{θ 03} ( λ , {θ}_{03} ) = f [ {n}_{1} ( λ ) , {k}_{1} ( λ ) , d , {θ}_{03} ] \qquad ( 20 )$$

A special case is no coatings on a substrate, i.e., d=0 and Y=η₂. In this case, the complex refractive index N₂=(n₂−jk₂) of an unknown substrate can be determined from two s-wave reflectance spectra measured at different incident angles of θ₀₁ and θ₀₂.
p-wave reflectance does not change monotonically with the incident angle regardless of the interface being a simple bulk material or a film on a substrate. Furthermore, near the Brewster angle (normally 60-70 degrees) the reflectance is small. As a result, measurements of the p-wave reflectance spectra at normal incident angle and at an oblique incident angle of about 60-70 degrees would not necessarily yield a set of unique solutions of the thin film's refractive index n₁ and extinction coefficient k₁.

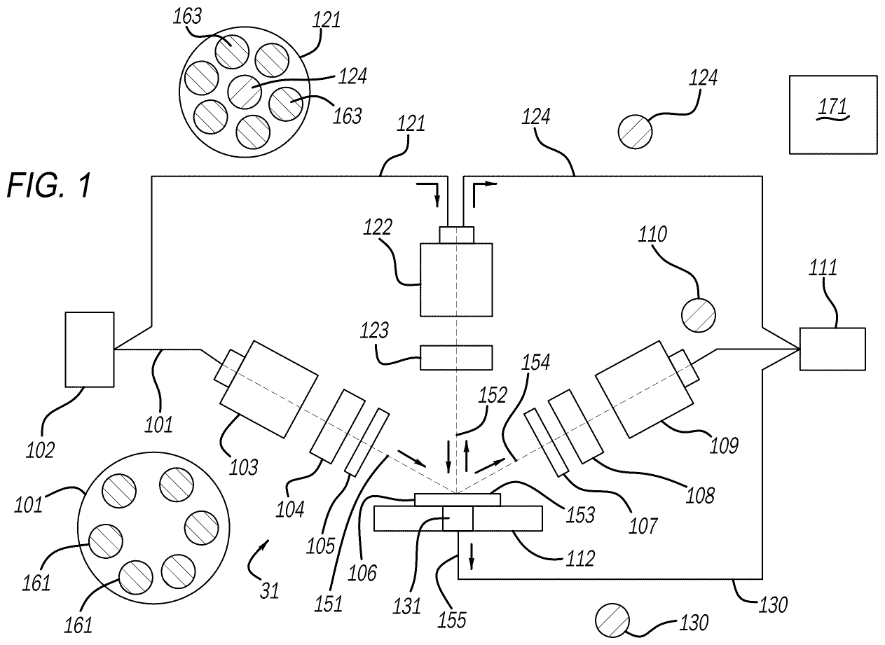

Based on the principle discussed above, a first preferred embodiment of a multi-function thin film analyzer 31 is illustrated in FIG. 1. This setup includes three modes that respectively measure 1) the reflectance at an incident angle θ₀>0 (e.g., 60 degrees), 2) the reflectance at normal incident angle θ₀=0, and 3) the transmittance at normal incidence. The components used in each measurement mode are described below.

Angled reflectance measurement: A light transmitting side includes fiber optical cable 101 is connected to a light source 102 at one end and an optical collimator 103 at the other end. Light source 102 is preferably a combination of Deuterium and halogen lamp but may alternately be a set of LEDs. A refocusing lens 104 is set after the collimator 103 and focuses the incident light on the surface of a sample 106. A polarizer 105 is located after the refocusing lens 104 to allow s-wave to pass through. A reflected light receiving and detection side is symmetrical to the transmitting and incident side, and includes an s-polarizer 107, a refocusing lens 108, a collimator 109, and a fiber optical cable 110 connected to a spectrometer detector 111.

Sample 106 is a thin film on a substrate, placed on a sample support or stage 112. The stage may be movable about five axes via one or more automated electromagnetic actuators, to allow for height and tilting angle adjustment to account for different sample thicknesses. Substrate is preferably a transparent glass sheet or silicon wafer, which has generally flat upper and lower faces.

Normal reflectance measurement: A bifurcated and light transmitting, fiber optical cable 121 is connected to light source 102 and an optical collimator 122. A refocusing lens 123 is set after collimator 122 and focuses the incident light on the surface of sample 106. The reflected light goes through bifurcated and receiving fiber optical cable 124 connected to the same spectrometer 111. Note that no polarizer is needed for normal incident reflectance measurements because s-wave and p-wave have the same reflectance at θ₀=0. Furthermore, an axial centerline direction 151 of a distal end of cable 101, collimator 104, lens 104 and polarizer 105 is offset angled by about 45-75 degrees relative to a sample surface normal (i.e., perpendicular) direction 152, and also offset angled relative to a planar face 153, and additionally offset angled relative to an axial centerline direction 154 of a distal end of cable 110, collimator 109, lens 108 and polarizer 107.

Normal transmittance measurement: The incident components are the same as the normal reflectance measurement. A fiber optical cable 130 is set behind sample 106 with a proximal end coupled within an aperture 131 of stage 112 and with a distal end connected to spectrometer 111. An axial centerline direction 155 of the proximal end of cable 130 is coaxially aligned with an axial centerline direction of lens 123, collimator 122 and distal ends of cables 121 and 124, in this embodiment.

More specifically, fiber optical cable 101 is a bundle of multiple, parallel and longitudinally elongated, optical fibers 161 which transmit the light from the light source 102 to collimator 103. Furthermore, fiber optical cable 121 is a bundle of parallel and longitudinally elongated, optical fibers 163 which transmit the light from the light source 102 to collimator 122. Additionally, at the distal end of cable 121 where it is coupled to collimator 122, it has the centrally located optical fiber 124 which is bifurcated away from the outer fibers 163, such that receiving fiber 124 extends between collimator 122 and spectrometer 111. Receiving cables 110 and 130 each consist of a single optical fiber. Protective sheaths may be used to surround the outside of the optical cables, and the cables are preferably flexible. Of course, different quantities of optical fibers may alternately be employed, although some of the present benefits may not be realized.

The normal incident modes function as a spectrophotometer that can measure the sample reflectance and transmittance spectra. By measuring the s-wave reflectance spectrum under an oblique incident angle of θ₀>0, the complex refractive index of a thin film deposited on a known substrate, the complex refractive index of an unknown substrate without a coating, or the film thickness can be determined, preferably in an automated and real-time manner using software instructions in a programmable controller 171, which is connected to spectrometer 111 and light source 102.

For thin film n₁ & k₁ analysis, it is desired to measure the reflectance of an unknown thin film deposited on a known substrate, such as single crystalline silicon, at two different incident angles. One angle is preferred to be 0 degrees, which is called the normal incidence. The other offset angle is between 0 and 90 degrees, exclusive, and preferably 45-75 degrees for easy operation. Other combinations of two different angles can be also used. For transmittance measurement, the film is usually deposited on a glass substrate.

Three measurements are performed at each angle for the normal and oblique reflectance measurements: 1) background spectrum I_{RB}(λ), 2) standard sample (e.g., single crystalline silicon wafer) reflection spectrum I_{RSi}(λ), and 3) sample reflection spectrum IRs (2). The measured spectrum I_{RSi}(λ) of the standard sample (e.g., silicon wafer) can be calibrated to the theoretical reflectance R_{Si}(λ) and subsequently used to determine the sample reflectance R_{S}(λ) as shown in equation (21) below.

$${R}_{S} ( λ ) = {R}_{S i} ( λ ) \frac{{1}_{R S} ( λ ) - {1}_{R B} ( λ )}{{1}_{R S i} ( λ ) - {1}_{R B} ( λ )} \qquad ( 21 )$$

Software instructions, run on programmable controller 171, are used to numerically resolve the reflectance Equation (8), where the film refractive index n₁ and extinction coefficient k₁ are integrated into two loops. The computed reflectance values at two angles are compared with the measured results. The solutions for n₁ and k₁ yield a minimum reflectance difference square as shown in equation (22) below.

$${\vert {R}_{C 0} ( λ ) - {R}_{S 0} ( λ ) \vert}^{2} + {\vert {R}_{C 60} ( λ ) - {R}_{S 60} ( λ ) \vert}^{2} = minimum \qquad ( 22 )$$

where R_{C0}(λ) and R_{S0}(λ) are the calculated and measured sample reflectance at an incident angle of 0 degrees, and R_{C60}(λ) and R_{S60}(λ) are the calculated and measured sample reflectance at an incident angle of 60 degrees.

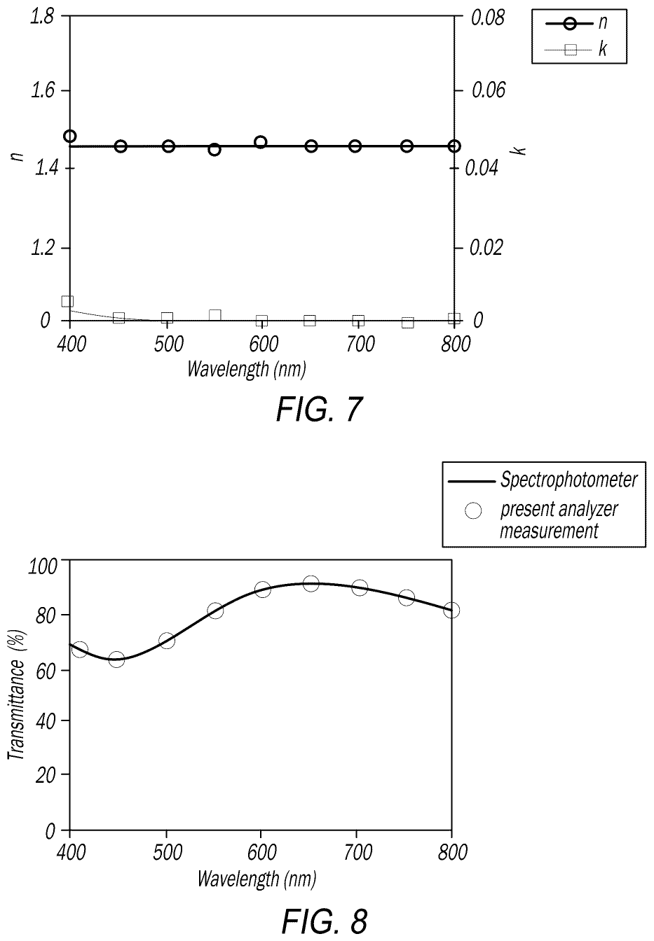

FIG. 6 shows the expected s-wave reflectance spectra of a SiO₂-coated Si sample measured at 0 and 60 degrees using the present analyzer 31. It is worth noting that the dot and square data points are of most relevance since the connecting lines in this figure are not necessarily indicative of the actual reflectance trend. From these two spectra, the film n₁ and k₁ values are derived by the software. The computation confirms that the n₁ and k₁ values are unique at each wavelength regardless of the ranges of n₁ and k₁ set in the computation loops, which is consistent with the s-wave characteristics. By way of comparison, the SiO₂/Si sample is also analyzed using an ellipsometer, yielding n₁ and k₁ values highly consistent with the results derived from the present combined instrument, as shown in FIG. 7, where the solid line represents conventional ellipsometry measurement results and the circle markers are the expected results obtained from the present analyzer 31. The results align which demonstrate the feasibility of the present analyzer and method.

The transmittance of optical coatings is measured at normal incidence, and it requires three measurements: 1) background spectrum I_{TB}(λ), 2) standard transmission spectrum I_{TAir}(λ) of air, which is 100%, and 3) sample transmission spectrum I_{TS}(λ). From these three measurements, the sample transmittance can be obtained by the programmable controller and its software, as shown in Equation (23) below:

$${T}_{s} ( λ ) = \frac{{1}_{T S} ( λ ) - {1}_{T B} ( λ )}{{1}_{TAir} ( λ ) - {1}_{T B} ( λ )} \times 100 \% \qquad ( 23 )$$

Referring now to FIG. 8, an expected transmittance spectrum of an Nb₂O₅ thin film coated on a glass substrate is measured using the present multi-function optical analyzer and a commercial spectrophotometer. The line indicates the conventional spectrophotometer results while the circles depict the results from the present analyzer. The results are almost identical which demonstrates the feasibility of the present analyzer and method.

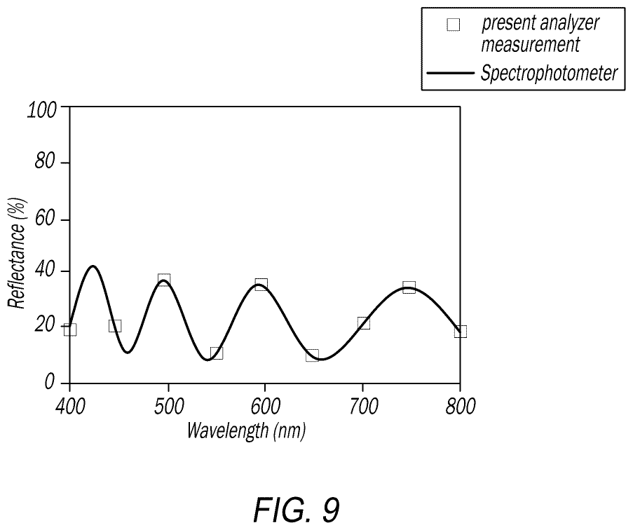

Next, FIG. 9 shows the expected reflectance spectra of a SiO₂ thin film coated on a crystalline silicon wafer, measured using the present multi-function optical analyzer and a commercial spectrophotometer, at normal incidence. Again, when the present optical analyzer is used to measure a sample's reflectance, three measurements are performed: 1) background spectrum I_{RB}(λ), 2) standard sample (e.g., single crystalline silicon wafer) reflection spectrum I_{RSi}(λ), and 3) sample reflection spectrum I_{RS}(λ). The measured spectrum I_{RSi}(λ) of the standard sample (e.g., silicon wafer) is calibrated to the theoretical reflectance R_{Si}(λ) and subsequently used to determine the sample reflectance R_{S}(λ) as shown in equation (21) described before. The two measured reflectance spectra match excellently which demonstrates the feasibility of the present analyzer and method.

Consideration is now given for film thickness measurements. In a long wavelength range, SiO₂ has negligible absorption with k₁=0. Using two reflectance spectra measured at different angles, two unknown film parameters n₁ and thickness d can be numerically calculated as discussed in the normal and oblique reflectance measurements. In comparison, a commercial SiO₂/Si sample has been measured. The derived thickness is ~300 nm using a single wavelength of 800 nm. The expected SiO₂ film thickness derived with the present analyzer is in excellent agreement with the actual thickness specified by the manufacturer. This method applies to any dielectric film that has nearly no absorption in the long wavelength range.

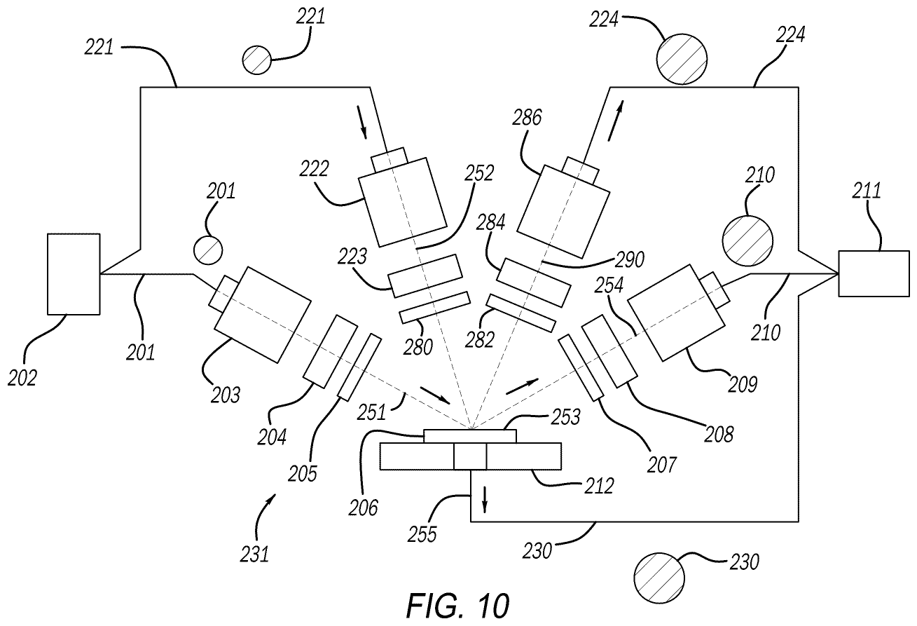

Reference is made to FIG. 10 for a second exemplary embodiment of the present analyzer 231. This configuration includes multiple, such as two, obliquely angled light source transmission feeds and polarized optics, emitted to a film and substrate sample 206 at primary light path directions diagonally offset between a film plane defined by an exterior face surface of the film and the nominal plane perpendicular to the exterior surface. These two primary light path directions are each angularly offset from each other, such that their primary directions and also the receiving primary direction for the spectrometer 111, are equilaterally offset from each other in a true view triangularly oriented manner.

More specifically, this embodiment has a light transmitting side which includes a fiber optical cable 201 having a proximal end connected to a light source 202 at one end and an optical collimator 203 at the opposite distal end. A refocusing lens 204 is positioned after collimator 203 and focuses the incident light on the surface of sample 206. A polarizer 205 is located after lens 204 to allow s-wave to pass through. A reflected light receiving and detection side includes an s-polarizer 207, a refocusing lens 208, a collimator 209, and a fiber optical cable 210 connected to a spectrometer detector 211.

A light transmitting, fiber optical cable 221 has a proximal end connected to light source 202 and a distal end connected to an optical collimator 222. A refocusing lens 223 is positioned after collimator 222 and focuses the incident light on the surface of sample 206. A polarizer 280 is located between lens 223 and the sample to allow s-wave to pass therethrough but hinder p-wave transmission.

The reflected light goes through a polarizer 282, a lens 284 and a collimator 286, and then passes along a receiving fiber optical cable 224 connected to the same spectrometer 211. Furthermore, an axial centerline direction 251 of a distal end of cable 201, collimator 204, lens 204 and polarizer 205 is offset angled relative to a sample surface normal (i.e., perpendicular) direction 252, and also offset angled relative to a planar face of the sample. Direction 251 is additionally offset angled relative to an axial centerline direction 254 of a distal end of cable 210, collimator 209, lens 208 and polarizer 207, and offset angled relative to an axial centerline direction 290 of a distal end of cable 224, collimator 286, lens 284 and polarizer 282. Thus, both of the light emittance directions are offset from each other, and both of the reflection receiving directions are offset from each other.

For a normal transmittance measurement, a fiber optical cable 230 is set behind sample 206 with a proximal end coupled within an aperture 231 of stage 212 and with a distal end connected to the same spectrometer 211. An axial centerline direction 255 of the proximal end of cable 230 is offset angled from directions 251, 252, 254 and 290.

Also different than the first embodiment, in the present analyzer 231, each of the light emitting cables 201 and 221 are preferably a single optical fiber of a smaller diameter than a larger diameter, single optic fiber of cables 224 and 230. This beneficially allows for easier alignment of the cables and capturing of the reflected light, to account for small angular deviations during setup and use. However, it is alternately envisioned that bundles of fibers may be employed, with the collective diameters or one or more of the receiving cables being greater than collective diameters of one or more of the light emitting cables.

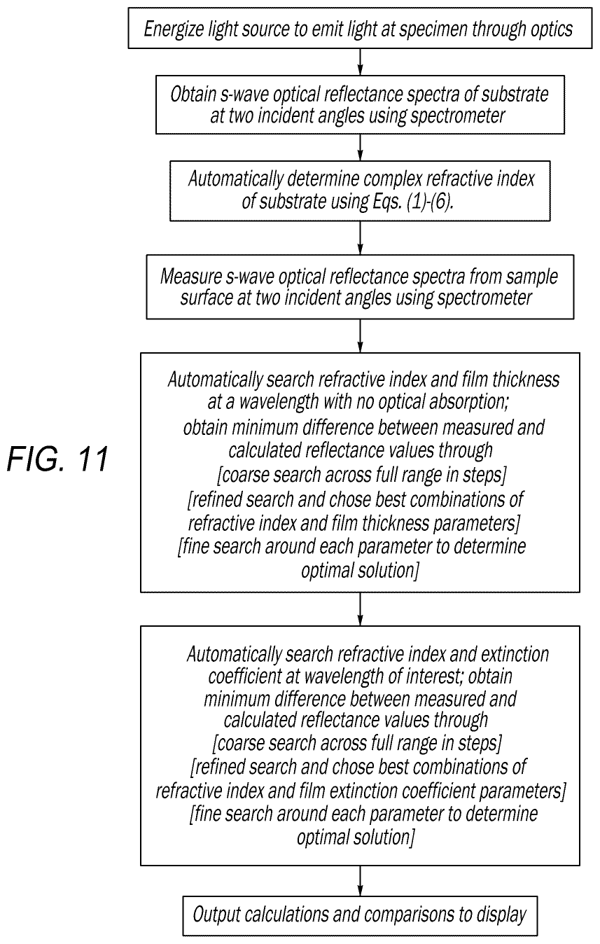

FIG. 11 is a software logic flow diagram for use by the programmable controller in either embodiment of the present optical analyzer. The software is stored in non-transient computer memory and includes: instructions configured to automatically cause energization of the light source to emit the light at the specimen; instructions configured to automatically obtain s-wave optical reflectance spectra at multiple incident angles from the spectrometer; instructions configured to automatically determine a refractive index from the spectra; instructions configured to automatically calculate a reflectance value based at least in part on the refractive index and detected film thickness at a wavelength with substantially no optical absorption; and instructions configured to automatically calculate a reflectance value based at least in part on the refractive index and an extinction coefficient at a wavelength of interest. The output calculations and comparisons are displayed on a display screen connected to the controller to monitor laboratory testing or real-time, in-line commercial manufacturing of film coated substrates.

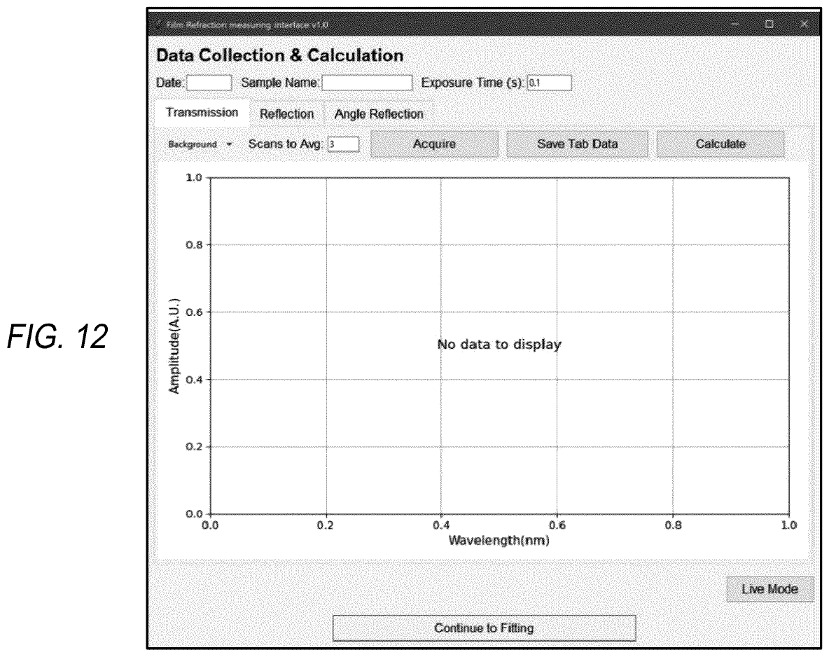

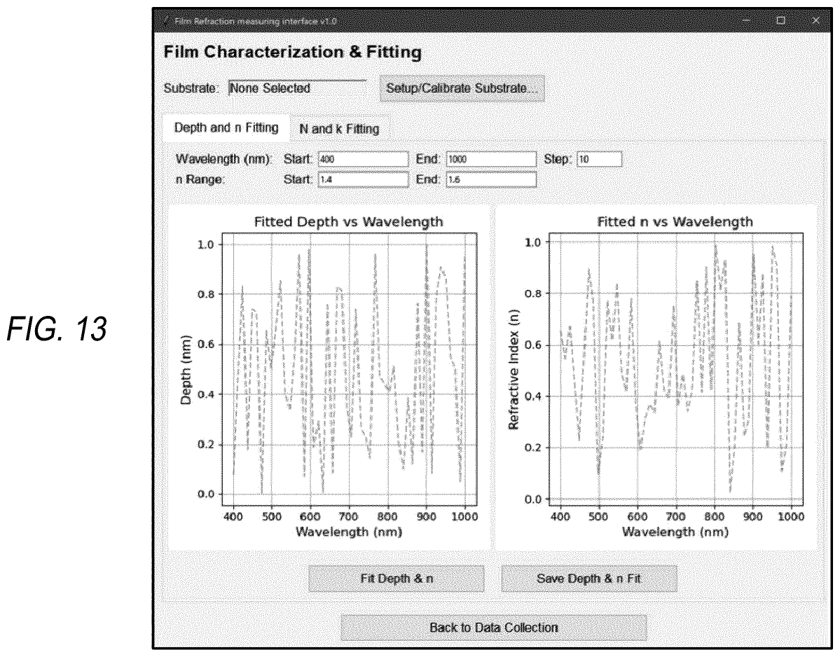

Exemplary graph user interfaces (“GUI”) employed on the display screen and using the software instructions, can be observed in FIGS. 12 and 13. FIG. 12 illustrates a data collection window while FIG. 13 depicts a result analysis window (with the curves therein merely being examples and not actual results), for the thin-film refractive index measurement and analysis software interface.

The workflow begins with a data collection window, where the user acquires transmission, reflection, and angled-reflection spectra using the relative measurement setup. The default spectral range is 400 to 1000 nm, and the acquisition time can be adjusted when measuring films with a high extinction coefficient. After collecting the required reflection datasets, the user switches to the analysis window. This window contains two modules: one for extracting film thickness and refractive index in the near-infrared region, and the other for determining the refractive index and extinction coefficient in the visible region. For each module, the user can select the wavelength range and define parameter limits before running the computation routine.

An accelerated computation program is set forth as follows. The algorithm is based on the Fresnel equations, which describe the wavelength-dependent reflectance at each interface. When reflectance is measured at two incident angles, any two of the three parameters (refractive index n, extinction coefficient k, and film thickness d) can be solved once the third is constrained. The fitting strategy initially uses a traversal-based search, where all candidate parameter sets are evaluated by computing simulated reflectance spectra. A root-mean-square error metric quantifies the difference between measured and simulated data, allowing the software program to automatically identify the optimal parameter set.

Although the traversal method guarantees the correct solution, it becomes computationally expensive when the user-defined parameter ranges are large. For example, if n is defined from 1.4 to 6.4 with a step size of 0.001 and k is defined from 0 to 1 with a step size of 0.0001, the total number of parameter combinations exceeds 50 million. Evaluating this full grid requires several minutes even for a single wavelength.

Therefore, to improve efficiency, an adaptive multi-stage computation method is implemented. Instead of searching for the full parameter space at the finest resolution, the algorithm proceeds in three stages. Using the previous example, the first stage performs a coarse search across the full range with a step size of 0.01 for both n and k. The five parameter sets with the lowest errors are then selected. In the second stage, each candidate is refined by searching within a ±0.1 neighborhood, and the three best combinations are chosen. The final stage performs a fine search within a ±0.01 range around each candidate to determine the optimal solution. This three-stage adaptive approach reduces the total number of evaluations from 50 million to approximately 265 thousand, which is about 0.53% of the original computational workload.

A computation example using this adaptive method is shown in FIG. 13 where the software program accurately finds the n and k values of an exemplary oxide thin film on a silicon substrate at five wavelength points. The total computation time is approximately one minute, and the calculated values closely match the reference data, demonstrating both the accuracy and efficiency of the analysis program.

The present multi-function optical analyzer can be differently summarized as follows, where the analyzer includes: (a) one set of obliquely arranged optical components for measuring optical s-wave reflectance spectrum from a sample surface at a defined incident angle in the range of 45-75 degrees relative to the sample surface normal direction; (b) one set of vertically arranged optical components for measuring the optical reflectance spectrum from a sample surface at an incident angle of 0 degrees relative to the sample surface normal direction; (c) one set of vertically arranged optical components for measuring optical transmittance spectrum through a sample at an incident angle of 0 degrees relative to the sample surface normal direction; (d) one light source that generates a spectrum of light in a range of interested wavelength with sufficient intensity; and (e) one spectrometer that can detect the reflected or transmitted light. Optionally, the incident side includes a light collimator connected to the light source through a fiber optical cable, a refocusing lens, and a polarizer working together to deliver a focused s-wave light at a defined angle to a sample surface; and the detection side includes a polarizer, a refocusing lens, and a light collimator connected to the spectrometer to detect the reflected s-wave light from a sample surface. Optionally, the incident components include a light collimator connected to the light source through a bifurcated fiber optical cable and a refocusing lens working together to deliver a focused light beam at an incident angle of zero degrees to a sample surface; and the reflection detection components include the same refocusing lens and light collimator as the incident components and a bifurcated fiber optical cable connected to the spectrometer. Optionally, the incident components include a light collimator connected to the light source through a fiber optical cable and a refocusing lens working together to deliver a focused light beam at an incident angle of zero degrees to a sample surface; and the transmission detection component includes a fiber optical cable connected to the spectrometer.

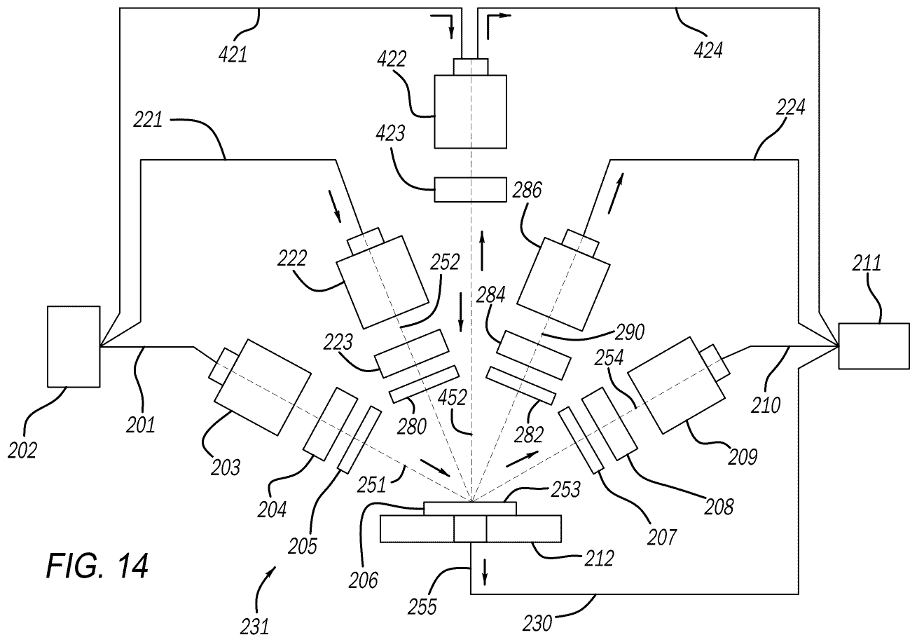

The present multi-function optical analyzer presented in FIG. 14 combines the features of both embodiments discussed hereinabove. This third embodiment can be summarized as including: (a) two sets of obliquely arranged optical components for measuring optical s-wave reflectance spectrum from the exposed surface 253 of the sample 206 at a defined incident angle in the range of 10-75 degrees relative to a sample surface normal direction 452; (b) one set of vertically arranged optical components for measuring the optical reflectance spectrum from a sample surface at an incident angle of 0 degrees relative to the sample surface normal direction 452; (c) one set of vertically arranged optical components for measuring optical transmittance spectrum through a sample at an incident angle of 0 degrees relative to the sample surface normal direction; (d) one light source 202 that generates a spectrum of light in a range of interested wavelength with sufficient intensity; and (e) one spectrometer 211 that can detect the reflected or transmitted light. More specifically, the incident side includes light collimators 203 and 222, connected to light source 202 through fiber optical cables 201 and 221, refocusing lenses 204 and 223, and polarizers 205 and 280, working together to deliver a focused s-wave light at a defined angle to sample surface 253; and the detection side includes polarizers 207 and 282, refocusing lenses 208 and 284, and light collimators 209 and 286, connected to spectrometer 211 to detect the reflected s-wave light from sample surface 253. Optionally, the incident components include another light collimator 422 connected to light source 202 through a bifurcated fiber optical cable 421, and a refocusing lens 423 working together to deliver a focused light beam at an incident angle of zero degrees to sample surface 253; and the reflection detection components include the same refocusing lens 423 and light collimator 422 as the incident components, plus a bifurcated fiber optical cable 424 connected to spectrometer 211. Optionally, the incident components include a light collimator connected to the light source through a fiber optical cable and a refocusing lens working together to deliver a focused light beam at an incident angle of zero degrees to a sample surface; and the transmission detection component includes a fiber optical cable connected to the spectrometer.

The present method of using a multi-function optical analyzer can be differently summarized as follows. A method to determine a refractive index of a bulk material, called a substrate, includes: (a) measuring optical s-wave reflectance spectrum from the sample surface at a defined incident angle in the range of 45-75 degrees relative to the sample surface normal direction; (b) measuring the optical reflectance spectrum from the sample surface at an incident angle of 0 degrees relative to the sample surface normal direction; (c) numerically solving the reflectance at wavelengths of interest within sufficiently broad ranges of refractive index and extinction coefficient, and the solutions for the sample refractive index and extinction coefficient yield a minimum difference between the measured and calculated reflectance values. Another configuration provides a method to determine the refractive index and extinction coefficient of a thin film with known thickness deposited on a substrate with known complex refractive index including: (a) measuring optical s-wave reflectance spectrum from a sample surface at a defined incident angle in the range of 45-75 degrees relative to the sample surface normal direction; (b) measuring the optical reflectance spectrum from a sample surface at an incident angle of 0 degrees relative to the sample surface normal direction; (c) numerically solving the reflectance at wavelengths of interest within sufficiently broad ranges of the film refractive index and extinction coefficient, and the solutions for the film refractive index and extinction coefficient yield a minimum difference between the measured and calculated reflectance values.

In yet another arrangement, a method to determine the refractive index and thickness of a dielectric thin film deposited on a substrate with known complex refractive index includes: (a) measuring optical s-wave reflectance spectrum from a sample surface at a defined incident angle in the range of 45-75 degrees relative to the sample surface normal direction; (b) measuring the optical reflectance spectrum from a sample surface at an incident angle of 0 degrees relative to the sample surface normal direction; (c) numerically solving the reflectance at a long wavelength at which the film extinction coefficient is zero and within sufficiently broad ranges of the film refractive index and film thickness, and the solutions for the film refractive index and thickness yield a minimum difference between the measured and calculated reflectance.

Various configurations of the present multi-function optical analyzer and method can be used. For example, thickness measurement may or may not be performed simultaneously with, or even at all, when measuring the transmittance and reflectance spectra, in an optional variation. While it is preferred that a single spectrometer detector is used, multiple spectrometer detectors may alternately be employed and/or different types of electrooptical detectors can be used, although some of the preferred cost reduction and simplicity features may not be achieved. It is also envisioned that the collimating, focusing and polarizing functions may be combined into a single or different optical components. Moreover, additional or fewer software instructions and optical component can be used. Features of one embodiment may be optionally interchanged with, and mixed and matched, with features of another embodiment. However, variations are not to be regarded as a departure from the spirit or the scope of the present invention.

The invention claimed is:

1. An optical analyzer for characterizing a film on a substrate, the optical analyzer comprising:
(a) a light source configured to emit light along:
(i) a first transmitting path including at least a first transmitting fiber optic cable and a first lens, a distal end of the first transmitting fiber optic cable having a first axial transmitting direction pointed toward the film;
(ii) a second transmitting path including at least a second transmitting fiber optic cable, a second lens and a transmitting polarizer, the transmitting polarizer being configured to filter out p-wave and transmit s-wave to the second lens and the film, and a distal end of the second transmitting fiber optic cable having a second axial transmitting direction pointed toward the film;
(iii) the first axial transmitting direction being offset angled from the second axial transmitting direction;
(b) at least one spectrometer configured to receive the light reflected from the film along:
(i) a first receiving path including at least a first receiving fiber optic cable, a distal end of the first receiving fiber optic cable having a first axial receiving direction pointed away from the film;
(ii) a second receiving path including at least a second receiving fiber optic cable, a third lens and a receiving polarizer, the receiving polarizer being configured to filter out p-wave and transmit s-wave to the second lens and the at least one spectrometer, and a distal end of the second receiving fiber optic cable having a second axial receiving direction pointed away from the film; and
(iii) the first axial receiving direction being offset angled from the second axial receiving direction.

2. The optical analyzer of claim 1, further comprising:
a stage upon which the sample is located, the stage including an aperture therein;
a fourth fiber optic cable having a proximal end coupled to the stage and extending from an opposite face from the sample, a distal end of the fourth fiber optic cable being connected to the at least one spectrometer; and
the fourth fiber optic cable being configured to receive light emitted from the light source through the film and the substrate.

3. The optical analyzer of claim 1, wherein the first lens in the first transmitting path also serves to focus the reflected light back from the sample along the first receiving path, the first axial transmitting direction and the first axial receiving direction being coaxial and at a normal angle relative to a facing plane of the film, and the second axial transmitting direction and the second axial receiving direction each being 45-75 degrees offset from the normal angle.

4. The optical analyzer of claim 1, wherein diameters of each of the first receiving fiber optic cable and of the second receiving fiber optic cable are at least 50% diameters of each of the first transmitting fiber optic cable and of the second transmitting fiber optic cable.

5. The optical analyzer of claim 1, further comprising a first fiber optic bundle includes the first transmitting fiber optic cable and a second fiber optic bundle includes the second transmitting fiber optic cable, and the first receiving fiber optic cable is part of the first fiber optic bundle for a partial length thereof.

6. The optical analyzer of claim 1, further comprising a programmable controller measuring and determining: a refractive index, an extinction coefficient, a thickness, an optical reflectance, and an optical transmittance of the film, based at least in part on output from the spectrometer.

7. The optical analyzer of claim 1, further comprising software, stored in non-transient computer memory, the software comprising:
(a) first instructions configured to automatically cause energization of the light source to emit the light at the specimen;
(b) second instructions configured to automatically obtain s-wave optical reflectance spectra at multiple incident angles from the spectrometer;
(c) third instructions configured to automatically determine a refractive index from the spectra;
(d) fourth instructions configured to automatically calculate a reflectance value based at least in part on the refractive index and detected film thickness at a wavelength with substantially no optical absorption; and
(e) fifth instructions configured to automatically calculate a reflectance value based at least in part on the refractive index and an extinction coefficient at a wavelength of interest.

8. The optical analyzer of claim 1, wherein the spectrometer and a programmable controller measure the reflectance spectra of polarized light at multiple different angles to directly calculate a refractive index of the film.

9. An optical analyzer for characterizing a film on a substrate, the optical analyzer comprising:
(a) a light source configured to emit light along:
(i) a first transmitting path including at least a first transmitting fiber optic cable and a first lens, a distal end of the first transmitting fiber optic cable having a first axial transmitting direction pointed toward the film;
(ii) a second transmitting path including at least a second transmitting fiber optic cable, and a distal end of the second transmitting fiber optic cable having a second axial transmitting direction pointed toward the film;
(iii) the first axial transmitting direction being offset angled from the second axial transmitting direction;
(b) at least one spectrometer configured to receive the light reflected from the film along:
(i) a first receiving path including at least a first receiving fiber optic cable, a distal end of the first receiving fiber optic cable having a first axial receiving direction pointed away from the film;
(ii) a second receiving path including at least a second receiving fiber optic cable, and a distal end of the second receiving fiber optic cable having a second axial receiving direction pointed away from the film;
(iii) the first axial receiving direction being offset angled from the second axial receiving direction;
(c) a programmable controller connected to the at least one spectrometer, the spectrometer and the programmable controller being configured to measure a reflectance spectra of polarized light at multiple different angles to directly determine the following with regard to the film:
(i) a refractive index;
(ii) an extinction coefficient;
(iii) a thickness;
(iv) an optical reflectance; and
(v) an optical transmittance.

10. The optical analyzer of claim 9, further comprising:
a stage upon which the sample is located, the stage including an aperture therein;
a fourth fiber optic cable having a proximal end coupled to the stage, a distal end of the fourth fiber optic cable being connected to the at least one spectrometer; and
the fourth fiber optic cable being configured to receive light emitted from the light source through the film and the substrate.

11. The optical analyzer of claim 9, wherein:
the second transmitting path further comprises a second lens and a transmitting polarizer, the transmitting polarizer being configured to filter out p-wave and transmit s-wave to the second lens and the film; and
the second receiving path further comprises a third lens and a receiving polarizer, the receiving polarizer being configured to filter out p-wave and transmit s-wave to the second lens and the at least one spectrometer.

12. The optical analyzer of claim 9, wherein the first and second transmitting paths each include a polarizer to transmit s-wave but not p-wave, and the first and second receiving paths each include a polarizer to transmit s-wave but not p-wave.

13. optical analyzer of claim 9, further comprising software, stored in non-transient computer memory, the software comprising:
(a) first instructions configured to automatically cause energization of the light source to emit the light at the specimen;
(b) second instructions configured to automatically obtain s-wave optical reflectance spectra at multiple incident angles from the spectrometer;
(c) third instructions configured to automatically determine a refractive index from the spectra;
(d) fourth instructions configured to automatically calculate a reflectance value based at least in part on the refractive index and detected film thickness at a wavelength with substantially no optical absorption; and
(e) fifth instructions configured to automatically calculate a reflectance value based at least in part on the refractive index and an extinction coefficient at a wavelength of interest.

14. The optical analyzer of claim 9, wherein the first lens in the first transmitting path also serves to focus the reflected light back from the sample along the first receiving path, the first axial transmitting direction and the first axial receiving direction being coaxial and at a normal angle relative to a facing plane of the film, and the second axial transmitting direction and the second axial receiving direction each being 45-75 degrees offset from the normal angle.

15. The optical analyzer of claim 9, wherein diameters of each of the first receiving fiber optic cable and of the second receiving fiber optic cable are at least 50% diameters of each of the first transmitting fiber optic cable and of the second transmitting fiber optic cable.

16. The optical analyzer of claim 9, further comprising a first fiber optic bundle includes the first transmitting fiber optic cable and a second fiber optic bundle includes the second transmitting fiber optic cable, and the first receiving fiber optic cable is part of the first fiber optic bundle for a partial length thereof.

17. A method of optically measuring characteristics of a film, the method comprising:
(a) emitting light along at least a first transmitting fiber optic cable toward a sample on a substrate;
(b) emitting light along at least a second transmitting fiber optic cable toward the sample;
(c) detecting the light reflected from the sample through at least a first receiving fiber optic cable;
(d) detecting the light reflected from the sample through at least a second receiving fiber optic cable;
(e) transmitting s-wave but not p-wave along the light received by the sample through at least one of the transmitting fiber optic cables;
(f) transmitting s-wave but not p-wave along the light transmitted along at least one of the receiving fiber optic cables;
(g) a programmable controller measuring a reflectance spectra of the reflected light at multiple different angles to directly determine the following with regard to the sample:
(i) a refractive index;
(ii) an extinction coefficient;
(iii) a thickness;
(iv) an optical reflectance; and
(v) an optical transmittance.

18. The method of claim 17, further comprising sending the light transmitting through the sample and the substrate through another fiber optic cable having a proximal end coupled to a stage, a distal end of the another fiber optic cable being connected to a spectrometer.

19. The method of claim 17, further comprising offset angling the first and second transmitting fiber optic cables from each other so that the light emitted from each is differently angled when received by the sample, and offset angling the first and second receiving fiber optic cables from each other so that the light received by each is differently angled when reflected by the sample.

20. An optical analyzer for characterizing a film on a substrate, the optical analyzer comprising:
(a) a light source;
(b) a first transmitting path including a first transmitting lens, the first transmitting path having a first axial transmitting direction pointed toward the film;
(c) a second transmitting path including a second transmitting lens and a transmitting polarizer, the transmitting polarizer being configured to filter out p-wave and transmit s-wave to the second transmitting lens and the film, and the second transmitting path having a second axial transmitting direction pointed toward the film;
(d) the first axial transmitting direction being offset angled from the second axial transmitting direction, both of which are offset angled from a plane of an exposed surface of the film and both of which are offset angled from a nominal direction that is perpendicular to the plane through the exposed surface of the film;
(e) a first receiving path including a first receiving lens, a distal end of the first receiving path having a first axial receiving direction pointed away from the film;
(f) a second receiving path including a second receiving lens and a receiving polarizer, the receiving polarizer being configured to filter out p-wave and transmit s-wave to the second receiving lens, and a distal end of the second receiving path having a second axial receiving direction pointed away from the film; and
(g) the first axial receiving direction being offset angled from the second axial receiving direction, both of which are offset angled from the plane of the exposed surface of the film and both of which are offset angled from the nominal direction that is perpendicular to the plane through the exposed surface of the film;
(h) a combined transmitting and receiving path including a lens, a distal end of the combined transmitting and receiving path having an axial direction that is coaxially aligned with the normal direction that is perpendicular to the plane through the exposed surface of the film;
(i) the first and the second receiving paths providing reflected light from the film along oblique sets of angles, that is received by at least one spectrometer to provide multiple and different oblique reflection measurements;
(j) the combined transmitting and receiving path providing reflected light from the film along the normal angle, that is received by the at least one spectrometer to provide a normal reflection measurement; and
(k) a programmable controller configured to use output from the at least one spectrometer to determine a refractive index, an extinction coefficient, film thickness directly from at least the three reflectance measurements and film transmittance.

21. A method of optically measuring characteristics of a film, the method comprising:
(a) measuring a reflectance spectra of polarized light at multiple different angles; and
(b) using a single instrument to determine the following with regard to the film:
(i) a refractive index;
(ii) an extinction coefficient;
(iii) a thickness;
(iv) an optical reflectance; and
(v) an optical transmittance; and
(c) the single instrument including both ellipsometry and spectrophotometry functions.
